(19) United States
(12) Patent Application Publication
(10) Pub. No.: US 2017/0164167 A1
(43) Pub. Date: Jun. 8, 2017

(54) Call notification method and electronic device

(71) Applicants: Le Holdings (Beijing) Co., Ltd., Beijing (CN); Lemobile Information Technology (Beijing) Co., Ltd., Beijing (CN)

(72) Inventor: Tianyu Li, Beijing (CN)

(73) Assignee: Le Holdings (Beijing) Co., Ltd.

(21) Appl. No.: 15/244,650

(22) Filed: Aug. 23, 2016

Related U.S. Application Data
(63) Continuation of application No. PCT/CN2016/088537, filed on Jul. 5, 2016.

(30) Foreign Application Priority Data
Dec. 7, 2015 (CN) 201510888204.8

(51) Int. Cl. H04W 4/12; H04M 3/22; H04M 3/42

(52) U.S. Cl. CPC H04W 4/12; H04M 3/42042; H04M 3/42059; H04M 3/2218

(57) ABSTRACT

The disclosure provides a call notification method and an electronic device. The method includes: when a call is received, acquiring contact person information corresponding to a calling number; according to the contact person information, determining a basic notification level of the calling number; acquiring a count of missed calls from the calling number within a preset time; according to the count of the missed calls, determining an additional notification level; according to the basic notification level and the additional notification level, acquiring a current notification level corresponding to the current calling number; acquiring a notification manner corresponding to the current notification level; and according to the notification manner, conducting a call notification for the calling number. The method and electronic device provided by the application avoids to a certain extent the situation of delaying an event because a user forgets to set a basic notification level of an important contact person to a higher level, and the current notification level determined thereby is more accurate. For each current notification level, a corresponding notification manner is selected to conduct a call notification, so that call notifications of contact persons in different notification levels are distinguished, and the user experience is good.

### CROSS REFERENCE TO RELATED APPLICATIONS

This application is a continuation of International Application No. PCT/CN2016/088537, filed on Jul. 5, 2016, which is based upon and claims priority to Chinese Patent Application No. 201510888204.8, filed on Dec. 7, 2015, titled “Call Notification Method and System”, and the entire contents of which are incorporated herein by reference.

### TECHNICAL FIELD

The application relates to the field of mobile communications, and particularly relates to a call notification method and an electronic device.

### BACKGROUND

With the development of the mobile communication technology and the continuous improvement of people's living standard, various kinds of mobile communication equipment have already become indispensable communication tools in people's life. As important mobile communication equipment in people's daily life, a mobile phone has a big user group. The mobile phone is generally set in a silence mode, a vibration mode, a ringing mode and other scenario modes. In general, the scenario mode of the mobile phone aims at all contact persons, that is, if the scenario mode is set to a non-silence mode, the calls and the short messages of all contact persons are both in the non-silence mode; and if the scenario mode is set to a silence mode, the calls and the short messages of all contact persons are both in the silence mode. However, many users have such a requirement that the mobile phone needs to be set in the silence mode when the user rests at night so as to avoid unnecessary disturbance, but the user hopes to receive a call as soon as possible when important persons, such as parents, etc., give calls if having urgent events.

The Chinese patent document No. CN102098371A discloses a device and method for grouping important phone numbers, and a mobile phone terminal. The device comprises: an important phone number editing unit used for editing a group of important phone numbers, incorporating important phone numbers into the group and/or removing the phone numbers from the group; an important phone number setting unit used for setting a notification manner corresponding to an important phone number; and an important phone number notification unit used checking whether an important phone number function is enabled when a call and short message are received, notifying a user in the notification manner set by the important phone number setting unit if the important phone number function is enabled, and performing processing in the manner set in accordance with the current scenario mode if the important phone number function is not enabled. In device disclosed in the above-mentioned patent document, it is realized that persons are grouped, so that when the scenario mode of the mobile phone is a silence mode, not the calls of all the contact persons are in the silence mode. However, in the solution disclosed in the patent document, only important phone numbers and unimportant phone numbers are distinguished, that is, only important contact persons and unimportant contact persons are distinguished, and the important contact persons need to be set manually, so that this is a missing Meanwhile, the degrees of importance of the important contact persons are also different in the real life, but in the patent document, the user is notified in the manner. To sum up, the device for grouping important phone numbers disclosed the patent document brings poor user experience.

### SUMMARY

The application provides a call notification method and an electronic device. The current notification level determined is more accurate, and call notifications of contact persons in different notification levels are distinguished, so that the user experience is good.

One objective of the embodiments of the present application is to provide a call notification method, comprising the following steps: when a call is received, acquiring contact person information corresponding to a calling number; according to the contact person information, determining a basic notification level of the calling number; acquiring a count of missed calls from the calling number within a preset time; according to the count of the missed calls, determining an additional notification level; according to the basic notification level and the additional notification level, acquiring a current notification level corresponding to the current calling number; acquiring a notification manner corresponding to the current notification level; and according to the notification manner, conducting a call notification for the calling number.

Preferably, the contact person information comprises contact person information prestored in an address book and/or historical call records corresponding to the calling number in a call log.

Preferably, the step of determining a basic notification level of the calling number according to the contact person information comprises: according to the prestored contact person information, acquiring a prestored notification level; according to the historical call records of the calling number, acquiring a historical notification level; and according to the prestored notification level and the historical notification level, determining a basic notification level corresponding to the calling number.

Preferably, the step of determining an additional notification level according to the count of the missed calls comprises: acquiring a threshold range corresponding to the count of the missed calls; and according to the threshold range, acquiring a corresponding additional notification level.

Preferably, the call notification method further comprises if a call from the calling number is not answered this time, conducting alarm clock reminding on the call event at an interval of a preset time.

Another objective of the embodiments of the application is to provide an electronic device, comprising at least one processor; and a memory communicably connected with the at least one processor for storing instructions executable by the at least one processor, wherein execution of the instructions by the at least one processor causes the at least one processor to: acquire contact person information corresponding to a calling number when a call is received; determine a basic notification level of the calling number according to the contact person information; acquire a count of missed calls from the calling number within a preset time; determine an additional notification level according to the count of the missed calls; acquire a current notification level corresponding to the current calling number according to the basic notification level and the additional notification level; acquire a notification manner corresponding to the current notification level; and conduct a call notification for the calling number according to the notification manner.

The electronic device, wherein, the contact person information comprises contact person information prestored in an address book and/or historical call records corresponding to the calling number in a call log.

The electronic device, wherein, the determining a basic notification level of the calling number according to the contact person information comprises: according to the prestored contact person information, acquiring a prestored notification level; according to the historical call records of the calling number, acquiring a historical notification level; and according to the prestored notification level and the historical notification level, determining a basic notification level corresponding to the calling number.

The electronic device, wherein, the determining an additional notification level according to the count of the missed calls comprises: acquiring a threshold range corresponding to the count of the missed calls; and according to the threshold range, acquiring a corresponding additional notification level.

The electronic device, wherein, if a call from the calling number is not answered this time, alarm clock reminding is conducted on the call event at an interval of a preset time.

A further objective of the embodiments of the application is to provide a non-transitory computer-readable storage medium storing executable instructions that, when executed by an electronic device, cause the electronic device to: acquire contact person information corresponding to a calling number when a call is received; determine a basic notification level of the calling number according to the contact person information; acquire a count of missed calls from the calling number within a preset time; determine an additional notification level according to the count of the missed calls; acquire a current notification level corresponding to the current calling number according to the basic notification level and the additional notification level; acquire a notification manner corresponding to the current notification level; and conduct a call notification for the calling number according to the notification manner.

The non-transitory computer-readable storage medium, wherein, the contact person information comprises contact person information prestored in an address book and/or historical call records corresponding to the calling number in a call log.

The non-transitory computer-readable storage medium, wherein the determining a basic notification level of the calling number according to the contact person information comprises: according to the prestored contact person information, acquiring a prestored notification level; according to the historical call records of the calling number, acquiring a historical notification level; and according to the prestored notification level and the historical notification level, determining a basic notification level corresponding to the calling number.

The non-transitory computer-readable storage medium, wherein, the determining an additional notification level according to the count of the missed calls comprises: acquiring a threshold range corresponding to the count of the missed calls; and according to the threshold range, acquiring a corresponding additional notification level.

The non-transitory computer-readable storage medium, wherein, if a call from the calling number is not answered this time, alarm clock reminding is conducted on the call event at an interval of a preset time.

The embodiment of the application provides a call notification method and an electronic device. The method comprises: when a call is received, acquiring contact person information corresponding to a calling number; according to the contact person information, determining a basic notification level of the calling number; acquiring a count of missed calls from the calling number within a preset time; according to the count of the missed calls, determining an additional notification level; according to the basic notification level and the additional notification level, acquiring a current notification level corresponding to the current calling number; acquiring a notification manner corresponding to the current notification level; and according to the notification manner, conducting a call notification for the calling number. When having an urgent or important event, a calling contact person may generally dial a number needing to be dialed many times. However, according to the method and electronic device of the application, an additional notification level is determined according to the count of the missed calls, and then a current notification level is determined according to the basic notification level and the additional notification level, so that the situation of delaying an event because a user forgets to set a basic notification level of an important contact person to a higher level is avoided to a certain extent, and the current notification level determined thereby is more accurate. Meanwhile, for each current notification level, a corresponding notification manner is selected to conduct a call notification, so that call notifications of contact persons in different notification levels are distinguished, and the user experience is good.

According to the call notification method and electronic device provided by the embodiment of the application, the contact person information comprises contact person information prestored in an address book and/or historical call records corresponding to the calling number in a call log. The degree of importance of a contact person is generally decided by the following two aspects: first, user presetting; and second, historical call records. According to the method and electronic device provided by the application, a prestored notification level is acquired according to the prestored contact person information; according to the historical call records of the calling number, a historical notification level is acquired; and according to the prestored notification level and the historical notification level, a basic notification level corresponding to the calling number is determined. The accuracy of the basic notification level obtained by the method and electronic device is higher, and the intelligent degree is high and accurate because the historical call records are obtained automatically without manual operation, thereby further preventing a user from forgetting to set a prestored notification level of a certain contact person to an important level.

According to the call notification method and electronic device provided by the embodiment of the application, a threshold range corresponding to the count of the missed calls is acquired; and according to the threshold range, a corresponding additional notification level is acquired. Therefore, the larger the count of calls from a certain number is, the higher the corresponding additional notification level is, so that an especially important event is further distinguished from a generally important event, and the user experience is optimized.

According to the call notification method and electronic device provided by the embodiment of the application, if a call from the calling number is not answered this time, alarm clock reminding is conducted on the call event at an interval of a preset time, thereby further preventing the user from missing to answer the call.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a specific example of a call notification method in accordance with the embodiment 1 of the application;

FIG. 2 is a flow chart of another specific example of the call notification method in accordance with the embodiment 1 of the application;

FIG. 3 is a flow chart of another specific example of the call notification method in accordance with the embodiment 1 of the application;

FIG. 4 is a schematic block chart of a specific example of a call notification system in accordance with the embodiment 2 of the application; and

FIG. 5 is a structural chart of hardware configuration of an electronic device performing the call notification method in accordance with the embodiment 4 of the application.

### REFERENCE SIGNS

1—contact person information acquiring module; 2—basic notification level determining module; 3—missed call count acquiring module; 4—additional notification level determining module; 5—current notification level determining module; 6—notification manner acquiring module; 7—notifying module.

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### EMBODIMENT 1

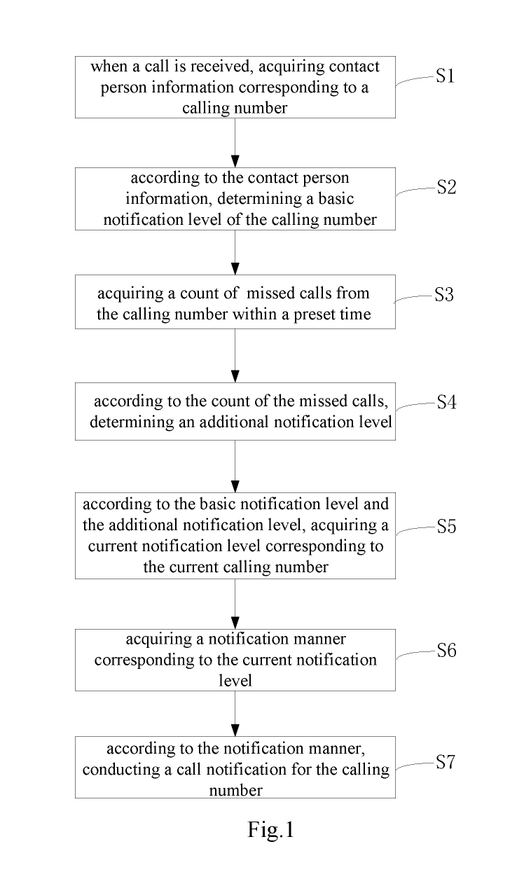

As shown in FIG. 1, this embodiment provides a call notification method, which may comprise the following steps:

In S1: when a call is received, contact person information corresponding to a calling number is acquired; wherein, because the degree of importance of a contact person is generally decided by the following two aspects: first, user presetting; and second, historical call records, the obtained contact person information may comprise contact person information prestored in an address book (preset by a user) and/or historical call records corresponding to the calling number in a call log;

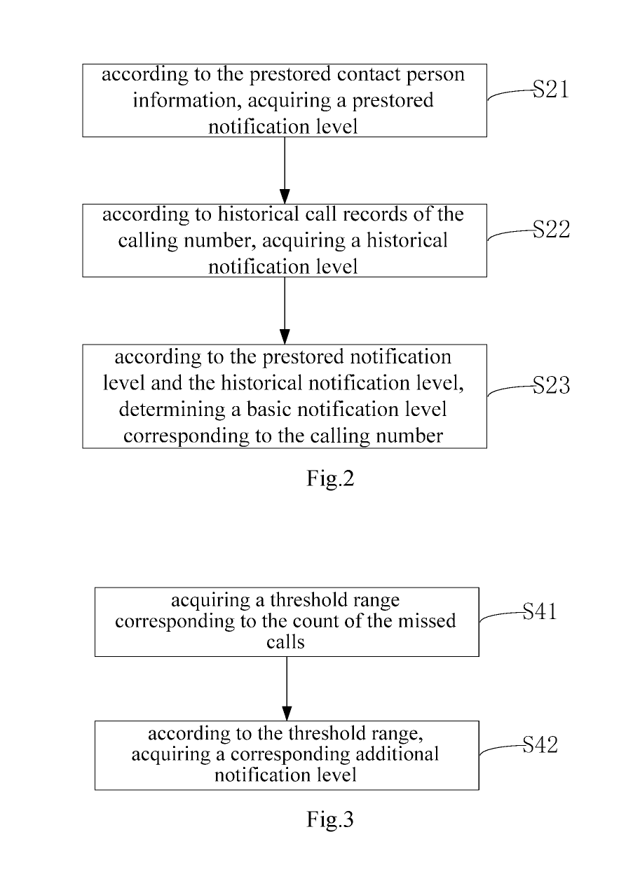

S2: according to the contact person information, determining a basic notification level of the calling number;

Wherein, as shown in FIG. 2, step S2 can be implemented specifically in the following manners:

In S21: according to the prestored contact person information, a prestored notification level is acquired, i.e. a notification level preset by the user, for example, no ringing in the silence mode, ringing and vibration in the silence mode, no ringing in any scenario mode, and the like;

In S22: according to historical call records of the calling number, a historical notification level is acquired; wherein, as a specific implementation manner, the historical notification level can be determined with historical call frequency and historical call duration; in general, it is considered that the higher the historical call frequency is and the longer the call duration is, the more important the contact person corresponding to the calling number is, that is, the higher the historical notification level is; in the actual use, a certain threshold can be set to conduct judgment, i.e. a threshold range corresponding to the historical call frequency and/or duration, and each level of threshold range corresponds to a historical notification level, specifically, the threshold range is set flexibly as required; and

In S23: according to the prestored notification level and the historical notification level, a basic notification level corresponding to the calling number is determined; wherein, the accuracy of the basic notification level obtained by steps S21 to S23 is higher, and the intelligent degree is high because the historical call records are obtained automatically without manual operation, thereby avoiding the occurrence of the situation of delaying an event because a user forgets to set a prestored notification level of a certain contact person to an important level;

In S3: a count of missed calls from the calling number within a preset time is acquired; wherein, when having an urgent or important event, a call contact person may generally dial a number needing to be dialed many times, so that it is very necessary to acquire the count of the missed calls within a preset time;

S4: according to the count of the missed calls, an additional notification level is determined;

Wherein, as shown in FIG. 3, step S4 can be implemented specifically in the following manners:

In S41: acquiring a threshold range corresponding to the count of the missed calls; and

In S42: according to the threshold range, acquiring a corresponding additional notification level;

Wherein, as a specific implementation manner, if the count of the missed calls is 0, the additional notification level is level 0; if the count of the missed calls is 1, the additional notification level is level 1; if the count of the missed calls is 2 to 3, the additional notification level is level 2; and if the count of the missed calls is greater than 3, the additional notification level is level 3; specifically, the notification level is set as required;

In general, the more urgent or more important the event is, the larger the count of calls is; and through step S41 and step S42, it is realized that the larger the count of calls from a certain number is, the higher the corresponding additional notification level is, and the additional notification levels are set hierarchically, so that an especially important event is further distinguished from a generally important event, and the user experience is optimized;

In S5: according to the basic notification level and the additional notification level, a current notification level corresponding to the current calling number;

Wherein, the following beneficial effects can be brought through steps S1 to S5: first, the situation of delaying an event because a user forgets to set a basic notification level of a certain important contact person (a certain calling number) to a higher level, and the user cannot answer the call when the important contact person calls the user's mobile phone repeatedly when having an urgent event is avoided to a certain extent; second, suppose that the current scenario is that the mobile phone of the user is in a silence mode, and the basic notification level of a certain calling number is no ringing in the silence mode; and at this moment, if the additional notification level is not set, the call from the number is always in the state of silence in the silence mode, i.e., even if the contact person of the calling number has an especially important event, and repeatedly calls the user's mobile phone, the user cannot detect it; however, by setting an additional notification level, the current notification level which is finally determined can be changed to ringing in the silence mode, thereby avoiding the occurrence of the situation of delaying an important event; to sum up, the current notification level determined through steps S1 to S5 is more objective and accurate;

S6: acquiring a notification manner corresponding to the current notification level, i.e. notification manners corresponding to all current notification levels are different, for example, only ringing; only vibration; ringing and vibration; different volumes of ringing; different amplitudes of vibration; no notification in the silence mode; only vibration notification in the silence mode; ringing and vibration notification in the silence mode, and the like; wherein, this step distinguishes call notifications of contact persons in different notification levels, and the user experience is good; and

S7: according to the notification manner, conducting a call notification on the calling number.

Although the occurrence of an event of missing to answer an important call can be avoided to a maximum extent through steps S1 to S7, an unexpected event still cannot be avoided, so that after step S7, the method may further comprise: a step of conducting alarm clock reminding on the call event at an interval of a preset time if a call from the calling number is not answered this time (that is, the user misses to answer a call). This setting further prevents the user from missing to answer the call.

### EMBODIMENT 2

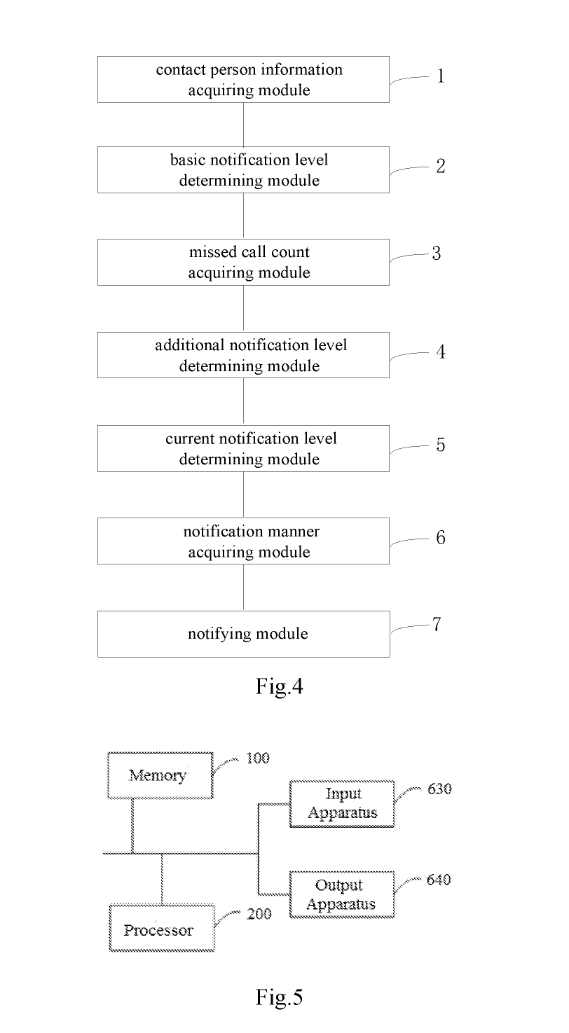

As shown in FIG. 4, this embodiment provides a call notification system, which may comprise:

a contact person information acquiring module 1 used for acquiring contact person information corresponding to a calling number when a call is received, wherein the contact person information may comprise contact person information prestored in an address book and/or historical call records corresponding to the calling number in a call log;

a basic notification level determining module 2 used for determining a basic notification level of the calling number according to the contact person information, wherein the module may further comprise:

a prestored notification level acquiring submodule used for acquiring a prestored notification level according to the prestored contact person information,

a historical notification level acquiring submodule used for acquiring a historical notification level according to the historical call records of the calling number, and

a basic notification level acquiring submodule used for determining a basic notification level corresponding to the calling number according to the prestored notification level and the historical notification level,

wherein the accuracy of the basic notification level obtained by the prestored notification level acquiring submodule, the historical notification level acquiring submodule and the basic notification level acquiring submodule is higher, and the intelligent degree is high because the historical call records are obtained automatically without manual operation, thereby preventing a user from forgetting to set a prestored notification level of a certain contact person to an important level;

a missed call count acquiring module 3 used for acquiring a count of missed calls from the calling number within a preset time, wherein when having an urgent or important event, a call contact person may generally dial a number needing to be dialed many times, so that it is very necessary to acquire the count of the missed calls within a preset time;

an additional notification level determining module 4 used for determining an additional notification level according to the count of the missed calls, wherein the module may further comprise: a threshold range acquiring submodule used for acquiring a threshold range corresponding to count of the missed calls, and an additional notification level acquiring submodule used for acquiring a corresponding additional notification level according to the threshold range,

wherein, in general, the more urgent or more important the event is, the larger the count of calls is, and by the threshold range acquiring submodule and the additional notification level acquiring submodule, it is realized that the larger the count of calls from a certain number is, the higher the corresponding additional notification level is, and the additional notification level is set hierarchically, so that an especially important event is further distinguished from a generally important event, and the user experience is optimized;

a current notification level determining module 5 used for acquiring a current notification level corresponding to the current calling number according to the basic notification level and the additional notification level;

a notification manner acquiring module 6 used for acquiring a notification manner corresponding to the current notification level; and

a notifying module 7 used for conducting a call notification for the calling number according to the notification manner.

When having an urgent or important event, a call contact person may generally dial a number needing to be dialed many times. However, the system provided by this embodiment determines the current notification level according to the basic notification level and the additional notification level, thereby avoiding to a certain extent the situation of delaying an event because a user forgets to set a basic notification level of an important contact person to a higher level, and the current notification level determined thereby is more objective and accurate. Meanwhile, for each current notification level, a corresponding notification manner is selected to conduct a call notification, so that call notifications of contact persons in different notification levels are distinguished, and the user experience is good.

Based on the above-mentioned solution, the call notification system provided by this embodiment further comprises a reminding module used for conducting alarm clock reminding on the call event at an interval of a preset time if a call from the calling number is not answered this time. This setting further prevents the user from missing to answer the call.

### EMBODIMENT 3

The embodiment provides a non-transitory computer-readable storage medium that stores computer-executable instructions, and the computer-executable instructions can perform the call notification method of any embodiment of the method.

The non-transitory computer-readable storage medium stores computer-executable instructions that, when executed by an electronic device, cause the electronic device to: acquire contact person information corresponding to a calling number when a call is received; determine a basic notification level of the calling number according to the contact person information; acquire a count of missed calls from the calling number within a preset time; determine an additional notification level according to the count of the missed calls; acquire a current notification level corresponding to the current calling number according to the basic notification level and the additional notification level; acquire a notification manner corresponding to the current notification level; and conduct a call notification for the calling number according to the notification manner.

The non-transitory computer-readable storage medium, wherein, the contact person information comprises contact person information prestored in an address book and/or historical call records corresponding to the calling number in a call log.

The non-transitory computer-readable storage medium, wherein the determining a basic notification level of the calling number according to the contact person information comprises: according to the prestored contact person information, acquiring a prestored notification level; according to the historical call records of the calling number, acquiring a historical notification level; and according to the prestored notification level and the historical notification level, determining a basic notification level corresponding to the calling number.

The non-transitory computer-readable storage medium, wherein, the determining an additional notification level according to the count of the missed calls comprises: acquiring a threshold range corresponding to the count of the missed calls; and according to the threshold range, acquiring a corresponding additional notification level.

The non-transitory computer-readable storage medium, wherein, if a call from the calling number is not answered this time, alarm clock reminding is conducted on the call event at an interval of a preset time.

### EMBODIMENT 4

FIG. 4 is a schematic diagram of the hardware configuration of the electronic device provided by the embodiment of the application, which performs the call notification method. As shown in FIG. 4, the electronic device includes: one or more processors 200 and a memory 100, wherein one processor 200 is shown in FIG. 4 as an example. The electronic device that performs the call notification method further includes an input apparatus 630 and an output apparatus 640.

The processor 200, the memory 100, the input apparatus 630 and the output apparatus 640 may be connected via a bus line or other means, wherein connection via a bus line is shown in FIG. 4 as an example.

The memory 100 is a non-transitory computer-readable storage medium that can be used to store non-transitory software programs, non-transitory computer-executable programs and modules, such as the program instructions/modules corresponding to the call notification method of the embodiments of the application (e.g. contact person information acquiring module 1, basic notification level determining module 2, missed call count acquiring module 3, additional notification level determining module 4, current notification level determining module 5, notification manner acquiring module 6, and the notifying module 7 shown in the FIG. 4). The processor 200 executes the non-transitory software programs, instructions and modules stored in the memory 100 so as to perform various function application and data processing of the server, thereby implementing the call notification method of the above-mentioned method embodiments

The memory 100 includes a program storage area and a data storage area, wherein, the program storage area can store an operation system and application programs required for at least one function; the data storage area can store data generated by use of a multimedia picture generation device. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to a call notification device via network connection. Examples of the aforementioned network include but not limited to internet, intranet, LAN, GSM, and their combinations.

The input apparatus 630 receives digit or character information, so as to generate signal input related to the user configuration and function control of the call notification device. The output apparatus 640 includes display devices such as a display screen.

The one or more modules are stored in the memory 100 and, when executed by the one or more processors 200, perform the call notification method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is:

1. A call notification method, comprising the following steps:
when a call is received, acquiring contact person information corresponding to a calling number;
according to the contact person information, determining a basic notification level of the calling number;
acquiring a count of missed calls from the calling number within a preset time;
according to the count of the missed calls, determining an additional notification level;
according to the basic notification level and the additional notification level, acquiring a current notification level corresponding to the current calling number;
acquiring a notification manner corresponding to the current notification level; and
according to the notification manner, conducting a call notification for the calling number.

2. The method of claim 1, wherein, the contact person information comprises contact person information prestored in an address book and/or historical call records corresponding to the calling number in a call log.

3. The method of claim 2, wherein, the step of determining a basic notification level of the calling number according to the contact person information comprises:
according to the prestored contact person information, acquiring a prestored notification level;
according to the historical call records of the calling number, acquiring a historical notification level; and
according to the prestored notification level and the historical notification level, determining a basic notification level corresponding to the calling number.

4. The method of claim 1, wherein, the step of determining an additional notification level according to the count of the missed calls comprises:
acquiring a threshold range corresponding to the count of the missed calls; and
according to the threshold range, acquiring a corresponding additional notification level.

5. The method of claim 1, further comprising: if a call from the calling number is not answered this time, conducting alarm clock reminding on the call event at an interval of a preset time.

6. An electronic device, comprising: at least one processor; and a memory communicably connected with the at least one processor for storing instructions executable by the at least one processor, wherein execution of the instructions by the at least one processor causes the at least one processor to: acquire contact person information corresponding to a calling number when a call is received; determine a basic notification level of the calling number according to the contact person information; acquire a count of missed calls from the calling number within a preset time; determine an additional notification level according to the count of the missed calls; acquire a current notification level corresponding to the current calling number according to the basic notification level and the additional notification level; acquire a notification manner corresponding to the current notification level; and conduct a call notification for the calling number according to the notification manner.

7. The electronic device of claim 6, wherein, the contact person information comprises contact person information prestored in an address book and/or historical call records corresponding to the calling number in a call log.

8. The electronic device of claim 7, wherein, the determining a basic notification level of the calling number according to the contact person information comprises: according to the prestored contact person information, acquiring a prestored notification level; according to the historical call records of the calling number, acquiring a historical notification level; and according to the prestored notification level and the historical notification level, determining a basic notification level corresponding to the calling number.

9. The electronic device of claim 6, wherein, the determining an additional notification level according to the count of the missed calls comprises: acquiring a threshold range corresponding to the count of the missed calls; and according to the threshold range, acquiring a corresponding additional notification level.

10. The electronic device of claim 6, wherein, if a call from the calling number is not answered this time, alarm clock reminding is conducted on the call event at an interval of a preset time.

11. A non-transitory computer-readable storage medium storing executable instructions that, when executed by an electronic device, cause the electronic device to: acquire contact person information corresponding to a calling number when a call is received; determine a basic notification level of the calling number according to the contact person information; acquire a count of missed calls from the calling number within a preset time; determine an additional notification level according to the count of the missed calls; acquire a current notification level corresponding to the current calling number according to the basic notification level and the additional notification level; acquire a notification manner corresponding to the current notification level; and conduct a call notification for the calling number according to the notification manner.

12. The non-transitory computer-readable storage medium of claim 11, wherein, the contact person information comprises contact person information prestored in an address book and/or historical call records corresponding to the calling number in a call log.

13. The non-transitory computer-readable storage medium of claim 12, wherein the determining a basic notification level of the calling number according to the contact person information comprises: according to the prestored contact person information, acquiring a prestored notification level; according to the historical call records of the calling number, acquiring a historical notification level; and according to the prestored notification level and the historical notification level, determining a basic notification level corresponding to the calling number.

14. The non-transitory computer-readable storage medium of claim 11, wherein, the determining an additional notification level according to the count of the missed calls comprises: acquiring a threshold range corresponding to the count of the missed calls; and according to the threshold range, acquiring a corresponding additional notification level.

15. The non-transitory computer-readable storage medium of claim 11, wherein, if a call from the calling number is not answered this time, alarm clock reminding is conducted on the call event at an interval of a preset time.
